(19) United States
(12) Patent Application Publication
(10) Pub. No.: US 2026/0124575 A1
(43) Pub. Date: May 7, 2026

(54) SOLAR-DRIVEN DEEP DEHUMIDIFICATION SYSTEM AND METHOD

(71) Applicant: City University of Hong Kong, Hong Kong (HK)

(72) Inventors: Xiaobo ZHANG, Hong Kong (HK); Duu-Jong LEE, Hong Kong (HK)

(21) Appl. No.: 19/366,549

(22) Filed: Oct. 23, 2025

Related U.S. Application Data
(60) Provisional application No. 63/717,845, filed on Nov. 7, 2024.

(51) Int. Cl. B01D 53/26; B01D 53/14; B01D 63/04; F24S 20/30

(52) U.S. Cl. CPC B01D 53/263; B01D 53/1425; B01D 53/1493; B01D 63/04; F24S 20/30; B01D 2257/80; B01D 2313/367

(57) ABSTRACT

The present invention provides solar-driven deep dehumidification system and method utilizing spectrum splitting of sunlight. The system comprises: multiple air dehumidification modules; and a solar energy conversion module configured to covert solar energy into thermal energy and electrical energy for driving the multiple air dehumidification modules. The multiple air dehumidification modules comprise: a liquid desiccant dehumidification module configured to configured to dehumidify a flow of air using a liquid desiccant to supply a flow of dehumidified air; and a vacuum membrane dehumidification module configured to configured to further dehumidify the flow of dehumidified air from the liquid desiccant dehumidification module to supply a flow deep-dehumidified air. The proposed systems pave a way for clean and sustainable deep dehumidification.

### CROSS-REFERENCE TO RELATED APPLICATIONS

The present application claims priority from the United States Provisional Patent Application No. 63/717,845 filed on 7 November, 2024, and the disclosure of which is incorporated herein by reference in its entirety.

### FIELD OF THE INVENTION

The present invention generally relates to the field of sustainable energy and dehumidification technologies, and more specifically relates to clean and deep dehumidification system and method utilizing spectrum splitting of sunlight.

### BACKGROUND OF THE INVENTION

Ultra-low humidity environment is always required in production workshop. However, creating such an environment consumes a significant amount of energy. To meet this demand, hybrid energy sources, including electrical energy and renewable energy, are commonly employed concurrently to generate air with ultra-low humidity. The reliance on hybrid energy partly results from the low utilization efficiency of renewable energy sources, such as solar energy. For example, Patent JP6116096B2 discloses a solar-powered dehumidification system including a solar energy conversion system and a solid dehumidification system, wherein sunlight is projected on the photovoltaic panel and converted to the electrical energy and thermal energy, and the thermal energy is utilized to drive the solid dehumidification system. But the electricity is not further utilized to achieve deep dehumidification. Patent CN103041675A discloses a solar-driven dehumidification system mainly encompassing a photovoltaic panel and a membrane regenerator. The solar energy is converted into electrical energy by the photovoltaic panel, and the electricity is utilized to drive the film regenerator. With electric energy, cations move towards the negative electrode while anions move towards the positive electrode. The solution can be concentrated in the regeneration room, and the solution concentration is diluted in the diluting chamber. However, in these approaches, only the electrical energy is utilized, the thermal energy converted from the solar energy is not utilized.

### SUMMARY OF THE INVENTION

One objective of the present invention is to provide a solar-powered deep dehumidification system and method with improved solar energy conversion and utilization efficiency.

In accordance with a first aspect of the present invention, the solar-driven deep dehumidification system comprises: multiple air dehumidification modules; and a solar energy conversion module configured to convert solar energy into thermal energy and electrical energy for driving the multiple air dehumidification modules; wherein the multiple air dehumidification modules comprise: at least one liquid desiccant dehumidification module configured to dehumidify a flow of air using a liquid desiccant to supply a flow of dehumidified air; and at least one vacuum membrane dehumidification module configured to configured to further dehumidify the flow of dehumidified air from the liquid desiccant dehumidification module to supply a flow deep-dehumidified air.

Preferably, the solar energy conversion module comprises a concentrator, a spectrum filter, a photovoltaic (PV) panel, a battery and a solar thermal collector.

Preferably, the concentrator is a parabolic trough, a parabolic dish, a linear fresnel reflector or a central tower receiver.

Preferably, the solar thermal collector is a flat-plate collector or an evacuated tube collector.

Preferably, the concentrator is configured to collect sunlight and concentrate the collected sunlight on to the spectrum filter; and the spectrum filter is configured to: split the collected sunlight into a short-wavelength band and a long-wavelength band; and project the short-wavelength band of sunlight on the PV panel and the long-wavelength band of sunlight on the solar thermal collector.

Preferably, the PV panel is configured to convert the short-wavelength band of sunlight into electrical energy to charge the battery; and the battery is configured to store the electrical energy and supply the electrical energy to the vacuum membrane dehumidification module and/or liquid desiccant dehumidification module.

Preferably, the solar thermal collector is configured to convert the long-wavelength band of sunlight into thermal energy for heating up a heat transfer medium which is used for transferring the thermal energy to the liquid desiccant dehumidification module.

Preferably, the heat transfer medium is air, heat transfer oil or water.

Preferably, the liquid desiccant dehumidification module comprises a dehumidifier configured to: receive a flow of humid air and a flow of cooled concentrated liquid desiccant; facilitate the flow of cooled concentrated liquid desiccant to dehumidify the flow of humid air to obtain a flow of dehumidified air; and discharge a flow of diluted liquid desiccant.

Preferably, the liquid desiccant dehumidification module further comprises a regenerator configured to: receive a flow of heated diluted liquid desiccant and a flow of dry air; facilitate the flow of heated diluted liquid desiccant to interact with the flow of dry air to release water absorbed therein to regenerate a flow of concentrated liquid desiccant; and discharge a flow of humidified air.

Preferably, the liquid desiccant dehumidification module further comprises: a first heat exchanger including: a first channel pneumatically and/or hydraulically coupled to the regenerator and a second channel pneumatically and/or hydraulically coupled to the solar energy conversion module; and being configured to supply the flow of heated diluted liquid desiccant to the regenerator by exchanging heat from the heat transfer medium to a flow of preheated diluted liquid desiccant.

Preferably, a second heat exchanger including a first channel pneumatically and/or hydraulically coupled to the dehumidifier and a second channel allowing a cooling medium to pass through; and being configured to supply the flow of cooled concentrated liquid desiccant to the dehumidifier by exchanging heat from a flow of precooled concentrated liquid desiccant to the cooling medium; and a third heat exchanger including: a first channel pneumatically and/or hydraulically coupled to the first heat exchanger and the dehumidifier; and a second channel pneumatically and/or hydraulically coupled to the regenerator and the second heat exchanger and being configured to: exchange heat from the flow of concentrated liquid desiccant to the flow of diluted liquid desiccant to obtain the flow of preheated diluted liquid desiccant and the flow of precooled concentrated liquid desiccant; and supply the flow of preheated diluted liquid desiccant and the flow of precooled concentrated liquid desiccant to the first and second heat exchangers respectively.

Preferably, the liquid desiccant dehumidification module further comprises a first solution pump configured to pump the flow of concentrated liquid desiccant from the regenerator into the second heat exchanger; and a second solution pump configured to pump the flow of diluted liquid desiccant from the dehumidifier to the second heat exchanger.

Preferably, the liquid desiccant dehumidification module further comprises: a first fan configured to force the flow of dry air into the regenerator; a second fan configured to force a flow of cooling air through the second heat exchanger; and a third fan configured to force the flow of humid air into the dehumidifier.

Preferably, the vacuum membrane dehumidification module comprises: a feeding chamber; one or more permeable cavities disposed within the feeding chamber; and a vacuum pumping module pneumatically coupled with the permeable cavities.

Preferably, the feeding chamber is configured to receive an inlet flow of air which is dehumidified by the liquid desiccant dehumidification module; the vacuum pumping module is configured to create vacuum environment in the permeable cavities such that water vapor within the inlet flow of air permeate into the permeable cavities due to water vapor pressure difference and the inlet flow of air is further dehumidified to obtain an outlet flow of deep-dehumidified air; and the feeding chamber is then configured to deliver the outlet flow of deep-dehumidified air to a user.

Preferably, the vacuum pumping modules include one or more vacuum pumps pneumatically connected in series.

Preferably, each permeable cavity is made of hollow fiber membranes.

Preferably, the one or more permeable cavities are pneumatically connected in series.

Preferably, the liquid desiccant is a LiBr solution, a LiCl solution or a HCOOK solution.

In accordance with a second aspect of the present invention, the solar-driven deep dehumidification method comprises: converting solar energy into thermal energy and electrical energy by a solar energy conversion module comprising a concentrator, a spectrum filter, a photovoltaic panel, a rechargeable battery, and a solar thermal collector; supplying the thermal energy to a liquid desiccant dehumidification module comprising a dehumidifier, a regenerator, and heat exchangers; dehumidifying, in the dehumidifier, a flow of humid air with a flow of cooled concentrated liquid desiccant to produce a flow of dehumidified air and a flow of diluted liquid desiccant; regenerating, in the regenerator, the flow of diluted liquid desiccant into a flow of concentrated liquid desiccant using a flow of dry air; supplying the electrical energy to a vacuum membrane dehumidification module comprising a feeding chamber, one or more permeable cavities, and a vacuum pumping module; and further dehumidifying the flow of dehumidified air by feeding the flow of dehumidified air into the feeding chamber and creating a vacuum environment in the permeable cavities such that water vapor within the flow of dehumidified air permeates into the permeable cavities due to a water vapor pressure difference, thereby obtaining a flow of deep-dehumidified air for delivery to a user.

By integrating renewable solar energy into dehumidification processes, the system provides an energy-efficient solution for dehumidification, reducing reliance on conventional energy sources and lowering operational costs, and promoting the use of sustainable energy sources and reducing the carbon footprint associated with traditional dehumidification methods. The present invention can achieve extremely low humidity levels (below 1 g/kg) and be used for air dehumidification in various settings, such as residential, commercial, and industrial environments, to maintain comfortable and healthy humidity levels in applications of climate control.

### Brief Description of Drawings

Embodiments of the invention are described in more detail hereinafter with reference to the drawings, in which:

FIG. 1 shows a schematic diagram of a solar-driven deep dehumidification system in according to one embodiment of the present invention;

FIG. 2 illustrates a flowchart of a solar-driven deep dehumidification method in according to one embodiment of the present invention.

### Detailed Description

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

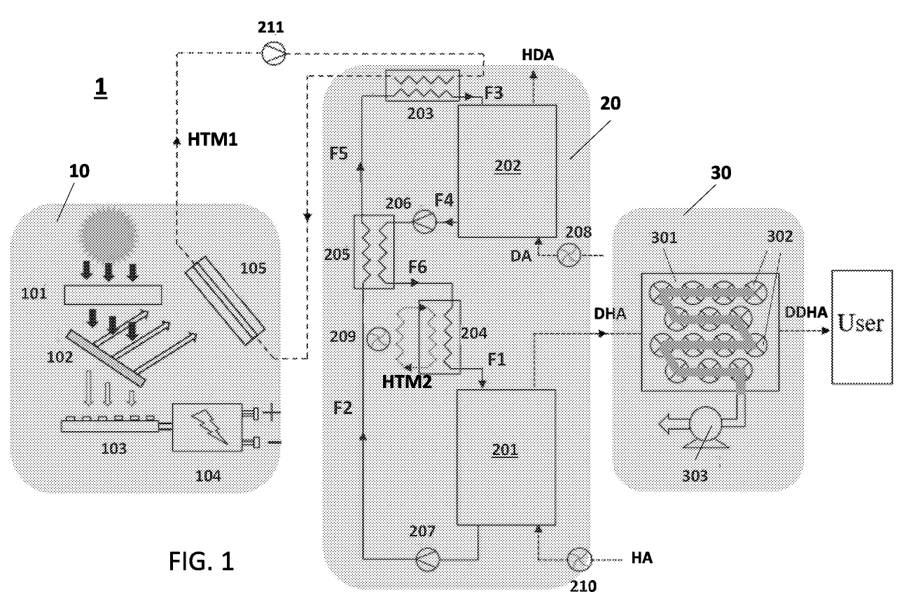

FIG. 1 shows a schematic diagram of a solar-driven deep dehumidification system 1 in according to one embodiment of the present invention. The solar-driven deep dehumidification system 1 includes a solar energy conversion module 10, a liquid desiccant dehumidification module 20, and a vacuum membrane dehumidification module 30. The solar energy conversion module 10 is configured to covert solar energy into thermal energy and electrical energy for driving the liquid desiccant dehumidification module 20 and the vacuum membrane dehumidification module 30. The liquid desiccant dehumidification module 20 is configured to dehumidify a flow of humid air (HA) using a liquid desiccant to supply a flow of dehumidified air (DHA). The vacuum membrane dehumidification module 30 is configured to further dehumidify the flow of dehumidified air from the liquid desiccant dehumidification module to supply a flow deep-dehumidified air.

The solar energy conversion module 10 comprises a concentrator 101, a spectrum filter (or beam splitter) 102, a photovoltaic (PV) panel 103, a rechargeable battery 104 and a solar thermal collector 105.

The concentrator 101 is configured to collect sunlight and concentrate the collected sunlight on to the spectrum filter 102. Different structural designs of concentrators may be used depending on practical implementation of the system. By way of example and without limitation, the concentrator 101 may be a parabolic trough-shaped concentrator, a parabolic dish-shaped concentrator, a linear fresnel reflector or a central tower receiver.

The spectrum filter 102 is configured to: split the collected sunlight into a short-wavelength band and a long-wavelength band; and project the short-wavelength band of sunlight on the PV panel 103 and the long-wavelength band of sunlight on the solar thermal collector 105.

The PV panel 103 is configured to convert the short-wavelength band of sunlight into electrical energy to charge the rechargeable battery 104. The PV panel may be constructed with, by way of examples and without limitation, PV cells made of silicon (Si), Gallium Arsenide (GaAs), Cadmium telluride (CdTe), Copper indium gallium selenide (CIGS), Germanium (Ge) and any suitable III-V compound semiconductors.

The rechargeable battery 104 is configured to store the electrical energy and supply power for operating the vacuum membrane dehumidification module. The rechargeable battery 104 may be made of, by way of examples and without limitation, Nickel-Metal Hydride (NiMH) battery or Lithium-Ion (Li-ion) battery.

The solar thermal collector 105 is configured to convert the long-wavelength band of sunlight into thermal energy for heating up a heat transfer medium HTM1 which in turn can be used for transferring the thermal energy to the liquid desiccant dehumidification module. The solar thermal collector 105 may be, by way of example and without limitation, a flat-plate collector or an evacuated tube collector. The heat transfer medium may be, by way of example and without limitation, air, water or heat transfer oil.

The liquid desiccant dehumidification module 20 comprises a dehumidifier 201, a regenerator 202, heat exchangers 203, 204, 205, solution pumps 206, 207, and fans 208, 209, 210.

The dehumidifier 201 is configured to: receive the flow of humid air and a flow of cooled concentrated (or strong) liquid desiccant F1; facilitate the flow of cooled concentrated liquid desiccant F1 to dehumidify the flow of humid air to obtain the flow of dehumidified air; and discharge a flow of diluted (or weak) liquid desiccant F2. The flow of humid air and the flow of cooled concentrated liquid desiccant F1 may be arranged as co-current flows, counter-current flows, or cross-current flows in the dehumidifier 201.

By way of example and without limitation, the liquid desiccant may be a Lithium Bromide (LiBr) solution, a LiCl (Lithium Chloride) solution or a potassium formate (HCOOK) solution.

The regenerator 202 is configured to: receive a flow of heated diluted liquid desiccant F3 and a flow of dry air (DA); facilitate the flow of heated diluted liquid desiccant F3 to interact with the flow of dry air to release water absorbed therein to regenerate a flow of concentrated liquid desiccant F4; and discharge a flow of humidified air (HDA). The flow of dry air and the flow of heated diluted liquid desiccant F3 may be arranged in co-current flow, counter-current flow, or cross-current flow configurations in the regenerator 202.

The heat exchanger 203 includes a first channel pneumatically and/or hydraulically coupled to the regenerator 202 and a second channel pneumatically and/or hydraulically coupled to the thermal collector 105. The heat exchanger 203 is configured to supply the flow of heated diluted liquid desiccant F3 to the regenerator 202 by exchanging heat from the heat transfer medium HTM1 from the thermal collector 105 to a flow of preheated diluted liquid desiccant F5.

The heat exchanger 204 includes a first channel pneumatically and/or hydraulically coupled to the dehumidifier 201 and a second channel allowing a cooling medium (or heat transfer medium) HTM2 to pass through.

The heat exchanger 204 is configured to: supply the flow of cooled concentrated liquid desiccant F1 to the dehumidifier 201 by exchanging heat from a flow of precooled concentrated liquid desiccant F6 to the cooling medium. The cooling medium may be, by way of example and without limitation, ambient air, water or heat transfer oil.

The heat exchanger 205 includes a first channel pneumatically and/or hydraulically coupled to the dehumidifier 201 and the heat exchanger 203; and a second channel pneumatically and/or hydraulically coupled to the regenerator 202 and the second heat exchanger 204.

The heat exchanger 205 is configured to exchange heat between the flow of concentrated liquid desiccant F4 and the flow of diluted liquid desiccant F2 to obtain the flow of preheated diluted liquid desiccant F5 and the flow of precooled concentrated liquid desiccant F6; and supply the flow of preheated diluted liquid desiccant F5 and the flow of precooled concentrated liquid desiccant F6 to the heat exchangers 203 and 204 respectively.

The liquid desiccant dehumidification module 20 further comprises: a solution pump 206 configured to pump the flow of concentrated liquid desiccant F4 from the regenerator 202 into the heat exchanger 205; and a solution pump 207 configured to pump the flow of diluted liquid desiccant F2 from the dehumidifier 201 to the heat exchanger 205. In some embodiments, the liquid desiccant dehumidification module 20 further comprises a solution pump 211 configured to pump the heat transfer medium HTM1 from the thermal collector 105 to the heat exchanger 203.

The liquid desiccant dehumidification module 20 further comprises: a fan 208 configured to force the flow of dry air to pass through the regenerator 202; a fan 209 configured to force an air flow (the cooling medium) through the heat exchanger 204; and a fan 210 configured to force the flow of humid air into the dehumidifier 201.

The vacuum membrane dehumidification module 30 includes a feeding chamber 301 and one or more permeable cavities 302 disposed within the feeding chamber 301. Each of the permeable cavities 322 may be made of hollow fiber membrane. The one or more permeable cavities 302 may be pneumatically connected in series.

The vacuum membrane dehumidification module 30 further includes a vacuum pumping module 303 pneumatically coupled with the permeable cavities 322. In some embodiments, the vacuum pumping modules may include one or more vacuum pumps pneumatically connected in series.

The feeding chamber 301 is configured to receive an inlet flow of air which is dehumidified by the liquid desiccant dehumidification module 20. The vacuum pumping module is configured to create vacuum environment in the permeable cavities 302 such that water vapor within the inlet flow of air permeate into the permeable cavities 302 due to water vapor pressure difference and the inlet flow of air is further dehumidified to obtain an outlet flow of deep-dehumidified air. The feeding chamber 301 is then further configured to deliver the outlet flow of deep-dehumidified air to a user.

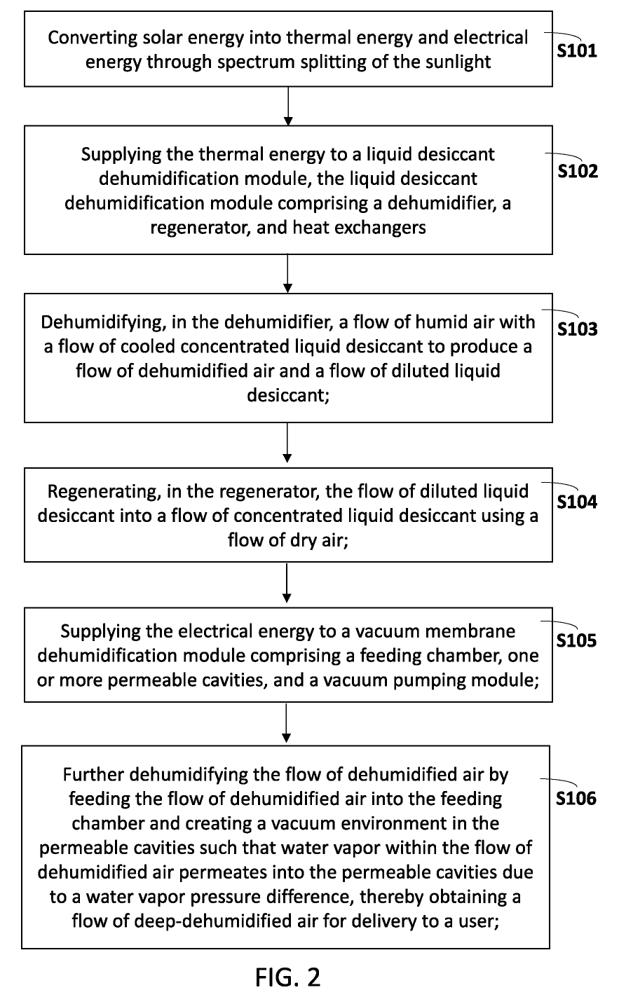

FIG. 2 illustrates a flowchart of a solar-driven deep dehumidification method in accordance with one embodiment of the present invention. Preferably, the method S100 is performed using the system of FIG. 1. As shown, the method S100 comprises the following steps:

S101: converting solar energy into thermal energy and electrical energy through spectrum splitting of the sunlight;

S102: supplying the thermal energy to a liquid desiccant dehumidification module, the liquid desiccant dehumidification module comprising a dehumidifier, a regenerator, and heat exchangers;

S103: dehumidifying, in the dehumidifier, a flow of humid air with a flow of cooled concentrated liquid desiccant to produce a flow of dehumidified air and a flow of diluted liquid desiccant;

S104: regenerating, in the regenerator, the flow of diluted liquid desiccant into a flow of concentrated liquid desiccant using a flow of dry air;

S105: supplying the electrical energy to a vacuum membrane dehumidification module comprising a feeding chamber, one or more permeable cavities, and a vacuum pumping module; and

S106: further dehumidifying the flow of dehumidified air by feeding the flow of dehumidified air into the feeding chamber and creating a vacuum environment in the permeable cavities such that water vapor within the flow of dehumidified air permeates into the permeable cavities due to a water vapor pressure difference, thereby obtaining a flow of deep-dehumidified air for delivery to a user.

In some embodiments, the method further comprises circulating the flow of concentrated liquid desiccant and the flow of diluted liquid desiccant between the dehumidifier and the regenerator by heat exchangers and solution pumps.

The functional units and modules in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A solar-driven deep dehumidification system, comprising:
multiple air dehumidification modules; and
a solar energy conversion module configured to covert solar energy into thermal energy and electrical energy for driving the multiple air dehumidification modules;
wherein the multiple air dehumidification modules comprise:
at least one liquid desiccant dehumidification module configured to configured to dehumidify a flow of air using a liquid desiccant to supply a flow of dehumidified air; and
at least one vacuum membrane dehumidification module configured to configured to further dehumidify the flow of dehumidified air from the liquid desiccant dehumidification module to supply a flow deep-dehumidified air.

2. The solar-driven deep dehumidification system according to claim 1, wherein the solar energy conversion module comprises a concentrator, a spectrum filter, a photovoltaic (PV) panel, a battery and a solar thermal collector.

3. The solar-driven deep dehumidification system according to claim 2, wherein the concentrator is a parabolic trough, a parabolic dish, a linear fresnel reflector or a central tower receiver.

4. The solar-driven deep dehumidification system according to claim 2, wherein the solar thermal collector is a flat-plate collector or an evacuated tube collector.

5. The solar-driven deep dehumidification system according to claim 2, wherein
the concentrator is configured to collect sunlight and concentrate the collected sunlight on to the spectrum filter; and
the spectrum filter is configured to: split the collected sunlight into a short-wavelength band and a long-wavelength band; and project the short-wavelength band of sunlight on the PV panel and the long-wavelength band of sunlight on the solar thermal collector.

6. The solar-driven deep dehumidification system according to claim 2, wherein
the PV panel is configured to convert the short-wavelength band of sunlight into electrical energy to charge the battery; and
the battery is configured to store the electrical energy and supply the electrical energy to the vacuum membrane dehumidification module and/or liquid desiccant dehumidification module.

7. The solar-driven deep dehumidification system according to claim 2, wherein the solar thermal collector is configured to convert the long-wavelength band of sunlight into thermal energy for heating up a heat transfer medium which is used for transferring the thermal energy to the liquid desiccant dehumidification module.

8. The solar-driven deep dehumidification system according to claim 7, wherein the heat transfer medium is air, heat transfer oil or water.

9. The solar-driven deep dehumidification system according to claim 1, wherein the liquid desiccant dehumidification module comprises a dehumidifier configured to: receive a flow of humid air and a flow of cooled concentrated liquid desiccant; facilitate the flow of cooled concentrated liquid desiccant to dehumidify the flow of humid air to obtain a flow of dehumidified air; and discharge a flow of diluted liquid desiccant.

10. The solar-driven deep dehumidification system according to claim 9, wherein the liquid desiccant dehumidification module further comprises a regenerator configured to: receive a flow of heated diluted liquid desiccant and a flow of dry air; facilitate the flow of heated diluted liquid desiccant to interact with the flow of dry air to release water absorbed therein to regenerate a flow of concentrated liquid desiccant; and discharge a flow of humidified air.

11. The solar-driven deep dehumidification system according to claim 10, wherein the liquid desiccant dehumidification module further comprises:
a first heat exchanger including: a first channel pneumatically and/or hydraulically coupled to the regenerator and a second channel pneumatically and/or hydraulically coupled to the solar energy conversion module; and being configured to supply the flow of heated diluted liquid desiccant to the regenerator by exchanging heat from the heat transfer medium to a flow of preheated diluted liquid desiccant;
a second heat exchanger including a first channel pneumatically and/or hydraulically coupled to the dehumidifier and a second channel allowing a cooling medium to pass through; and being configured to supply the flow of cooled concentrated liquid desiccant to the dehumidifier by exchanging heat from a flow of precooled concentrated liquid desiccant to the cooling medium; and
a third heat exchanger including: a first channel pneumatically and/or hydraulically coupled to the first heat exchanger and the dehumidifier; and a second channel pneumatically and/or hydraulically coupled to the regenerator and the second heat exchanger and being configured to: exchange heat from the flow of concentrated liquid desiccant to the flow of diluted liquid desiccant to obtain the flow of preheated diluted liquid desiccant and the flow of precooled concentrated liquid desiccant; and supply the flow of preheated diluted liquid desiccant and the flow of precooled concentrated liquid desiccant to the first and second heat exchangers respectively.

12. The solar-driven deep dehumidification system according to claim 11, wherein the liquid desiccant dehumidification module further comprises:
a first solution pump configured to pump the flow of concentrated liquid desiccant from the regenerator into the second heat exchanger; and
a second solution pump configured to pump the flow of diluted liquid desiccant from the dehumidifier to the second heat exchanger.

13. The solar-driven deep dehumidification system according to claim 12, wherein the liquid desiccant dehumidification module further comprises:
a first fan configured to force the flow of dry air into the regenerator;
a second fan configured to force a flow of cooling air through the second heat exchanger; and
a third fan configured to force the flow of humid air into the dehumidifier.

14. The solar-driven deep dehumidification system according to claim 1, wherein the vacuum membrane dehumidification module comprises:
a feeding chamber;
one or more permeable cavities disposed within the feeding chamber; and
a vacuum pumping module pneumatically coupled with the permeable cavities.

15. The solar-driven deep dehumidification system according to claim 14, wherein
the feeding chamber is configured to receive an inlet flow of air which is dehumidified by the liquid desiccant dehumidification module;
the vacuum pumping module is configured to create vacuum environment in the permeable cavities such that water vapor within the inlet flow of air permeate into the permeable cavities due to water vapor pressure difference and the inlet flow of air is further dehumidified to obtain an outlet flow of deep-dehumidified air; and
the feeding chamber is then configured to deliver the outlet flow of deep-dehumidified air to a user.

16. The solar-driven deep dehumidification system according to claim 14, wherein the vacuum pumping modules include one or more vacuum pumps pneumatically connected in series.

17. The solar-driven deep dehumidification system according to claim 14, wherein each permeable cavity is made of hollow fiber membranes.

18. The solar-driven deep dehumidification system according to claim 14, wherein the one or more permeable cavities are pneumatically connected in series.

19. The solar-driven deep dehumidification system according to claim 1, wherein the liquid desiccant is a LiBr solution, a LiCl solution or a HCOOK solution.

20. A solar-driven deep dehumidification method, comprising:
converting solar energy into thermal energy and electrical energy by a solar energy conversion module comprising a concentrator, a spectrum filter, a photovoltaic panel, a rechargeable battery, and a solar thermal collector;
supplying the thermal energy to a liquid desiccant dehumidification module comprising a dehumidifier, a regenerator, and heat exchangers;
dehumidifying, in the dehumidifier, a flow of humid air with a flow of cooled concentrated liquid desiccant to produce a flow of dehumidified air and a flow of diluted liquid desiccant;
regenerating, in the regenerator, the flow of diluted liquid desiccant into a flow of concentrated liquid desiccant using a flow of dry air;
supplying the electrical energy to a vacuum membrane dehumidification module comprising a feeding chamber, one or more permeable cavities, and a vacuum pumping module; and
further dehumidifying the flow of dehumidified air by feeding the flow of dehumidified air into the feeding chamber and creating a vacuum environment in the permeable cavities such that water vapor within the flow of dehumidified air permeates into the permeable cavities due to a water vapor pressure difference, thereby obtaining a flow of deep-dehumidified air for delivery to a user.
